(19) United States
(12) Patent Application Publication
(10) Pub. No.: US 2022/0234750 A1
(43) Pub. Date: Jul. 28, 2022

(54) FUEL TANK ASSEMBLIES

(71) Applicant: AIRBUS OPERATIONS LIMITED, Bristol (GB)

(72) Inventors: Martin LEE, Bristol (GB); Jay WHEELWRIGHT, Bristol (GB)

(21) Appl. No.: 17/584,898

(22) Filed: Jan. 26, 2022

(30) Foreign Application Priority Data
Jan. 27, 2021 (GB) 2101100.2

(51) Int. Cl. B64D 37/02; B64D 37/32

(52) U.S. Cl. CPC B64D 37/02; B64D 37/32

(57) ABSTRACT

A vehicle fuel tank assembly including a tank for storing fuel and a sensor device disposed inside the tank. The sensor device is integrated with a component of the tank. The sensor device detects the presence of a plurality of different chemical and/or biological entities in fuel stored in the tank. The plurality of different chemical and/or biological entities are suitable for use in determining whether at least two different types of contaminant are present in the fuel.

### RELATED APPLICATION

This application incorporates by reference and claims priority to United Kingdom patent application GB 2101100.2, filed Jan. 27, 2021.

### TECHNICAL FIELD

The present invention relates to a vehicle fuel tank assembly, to a fuel contaminant detection system comprising such a fuel tank assembly, and to an aircraft comprising such a fuel tank assembly.

### BACKGROUND

Although aviation fuel is sterile when it is produced, during the course of storing it external to an aircraft, transferring it onto an aircraft, and storing it in an aircraft fuel tank it is not uncommon for the fuel to become contaminated. The most common contaminates found in aviation fuel in an aircraft fuel tank are particulates (e.g. particles of rust, dust, pollen, rubber, fabric or the like), water; other petroleum products; Diesel Exhaust Fluid (DEF); and microbes (e.g. bacteria, fungi). The likelihood of contaminants being present in an aircraft fuel tank, particularly water and microbes, increases with the length of time that an aircraft is left parked with fuel in the tank.

The sensing capabilities built into the fuel systems of conventional aircraft are configured to measure physical properties of the fuel, such as volume, density, temperature and the like. Although it may be possible to detect water contamination using these sensors, it is not possible to detect other common types of contaminant. Instead, airlines must use standalone lab test kits to test fuel samples taken from within the fuel tanks of their aircraft, to check that they are free of all types of contamination. These test kits are expensive, and the process of using them is time-consuming.

An improved way to detect whether aviation fuel in an aircraft fuel tank is contaminated is therefore desired.

### SUMMARY

A first aspect of the present invention provides a vehicle fuel tank assembly comprising a tank for storing fuel and a sensor device disposed inside the tank. The sensor device is integrated with a component of the tank. The sensor device is configured to detect the presence of a plurality of different chemical and/or biological entities in fuel stored in the tank. The plurality of different chemical and/or biological entities are suitable for use in determining whether at least two different types of contaminant are present in the fuel.

Optionally, the component is located at a lowest point of the fuel tank in a normal operational orientation of a vehicle in which the fuel tank is comprised.

Optionally, the component is a removable component.

Optionally, the component is configured to form part of the fuel tank during normal operation of a vehicle in which the fuel tank is comprised.

Optionally, the component is a manhole cover or a drain valve.

Optionally, the component is a temporary cover panel configured to form part of the fuel tank during a non-operational period of a vehicle in which the fuel tank is comprised.

Optionally, the sensor device comprises a plurality of sub-sensors, each sub-sensor being configured to detect a different biological or chemical entity.

Optionally, the sensor device further comprises a communications interface configured to receive detection information from the plurality of sub-sensors, the detection information being indicative of whether or not each of the chemical or biological entities which the plurality of sub-sensors is configured to detect is present in fuel contained in the fuel tank. Optionally the communications interface is configured to transmit the received detection information to a remote processing device located outside of the fuel tank.

Optionally, the sensor device is configured to obtain a sample of fuel contained in the fuel tank and to determine whether or not each of the at least two different types of contaminant is present in the sample.

Optionally, the at least two different types of contaminant comprise any combination of: water; particulates; bacteria; fungi; Diesel Exhaust Fluid; petroleum products different to the fuel intended to be present in the fuel tank; other chemical contaminates.

Optionally, the sensor device comprises a lab-on-a-chip device.

Optionally, the lab-on-a-chip device is based on microfluidic technology.

Optionally, the sensor device comprises one or more biorecognition elements.

Optionally, the fuel tank assembly is an aircraft fuel tank assembly.

A second aspect of the invention provides a fuel contaminant detection system comprising a vehicle fuel tank assembly according to the first aspect, and a processing device. The sensor device of the vehicle fuel tank assembly is configured to transmit detection information to a processing device located outside of the fuel tank. The processing device is configured to receive detection information from the sensor device and to determine whether or not each of at least two different types of contaminant is present in fuel contained in the fuel tank based on the received detection information.

A third aspect of the invention provides an aircraft comprising a vehicle fuel tank assembly according to the first aspect.

### BRIEF DESCRIPTION OF THE DRAWINGS

Embodiments of the invention will now be described, by way of example only, with reference to the accompanying drawings, in which:

FIG. 1 is a schematic cross-section through an example vehicle fuel tank assembly according to the invention;

FIG. 2a is a schematic perspective view of a first example component of a vehicle fuel tank according to the invention;

FIG. 2b is a schematic side view of an alternative example component of a vehicle fuel tank according to the invention;

FIG. 2c is a schematic perspective view of a further alternative example component of a vehicle fuel tank according to the invention;

FIG. 3 is a schematic view of an example sensor device according to the invention;

FIGS. 4a and 4b are schematic views of exemplarily fuel contaminant detection systems according to the invention; and

FIG. 5 is a front view of an example aircraft according to the invention.

### DETAILED DESCRIPTION

The following description discusses examples of vehicle fuel tank assemblies according to the invention. Each such example vehicle fuel tank assembly comprises a tank for storing fuel and a sensor device disposed inside the tank. The sensor device is integrated with a component of the tank, and is configured to detect the presence of a plurality of different chemical and/or biological entities in fuel stored in the tank. The plurality of different chemical and/or biological entities is suitable for use in determining whether at least two different types of contaminant are present in the fuel.

The vehicle fuel tank assemblies according to the invention thereby confer the advantage that contaminants can be detected without an operator needing to extract a sample of fuel from the tank and run that sample through a separate test device. This enables the possibility of automatic monitoring for contaminants, periodically or continuously during a period when the vehicle is parked, which significantly reduces the time and expense of checking whether stored fuel is contaminated. Furthermore, since multiple different types of contaminant can be detected, the vehicle fuel tank assemblies according to the invention offer the possibility of providing a definitive determination of the condition of the stored fuel.

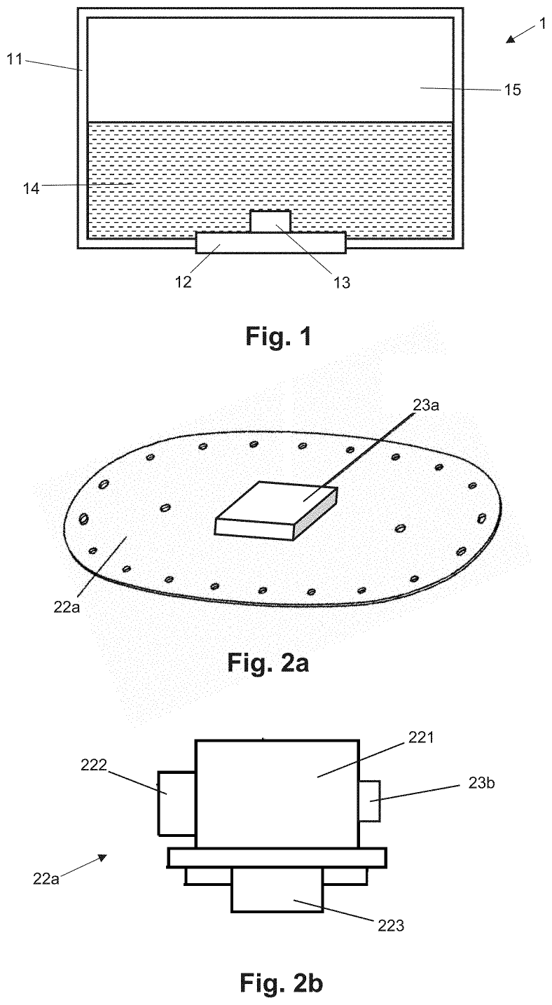

FIG. 1 is a cross-section through a generic example vehicle fuel tank assembly 1 according to the invention. The fuel tank assembly 1 is shown in the orientation it would have when a vehicle in which the fuel tank assembly 1 is comprised is in a normal operational orientation. The fuel tank assembly 1 comprises a tank suitable for storing fuel, and a sensor device 13. The tank is formed by a main wall structure 11 (which may be formed from multiple sub-structures joined in any suitable manner) and a component 12. The main wall structure 11 and the component 12 together define a substantially enclosed fuel containment space. In FIG. 1 the tank is shown partially filled with fuel 14. An ullage space 15 is present above the fuel 14.

The fuel tank assembly 1 is configured to be comprised in a vehicle. In some examples the main wall structure 11 of the tank is formed by the structure of a vehicle in which the fuel tank assembly 1 is comprised. In some examples the vehicle is an aircraft, in which cases the main wall structure 11 may be formed by an aircraft structure. In some examples the main wall structure 11 is formed by an aircraft wing box. The main wall structure 11 may be formed by two or more aircraft components, which may include for example one or more spars, ribs and/or skin panels.

The component 12 may be any component which forms part of the fuel tank. Preferably the component 12 is located towards the bottom of the fuel tank in a normal operational orientation of a vehicle in which the fuel tank assembly 1 is comprised. The component 12 may be located at a lowest point of the fuel tank in a normal operational orientation of the vehicle. This ensures that the sensor device 12 will be in contact with fuel stored in the tank even when the fuel level is very low. It is advantageous for the component 12 to be configured to be removable during normal operation of a vehicle in which the fuel tank assembly 1 is comprised. By “removable during normal operation” is meant that no disassembly and/or no significant period of inoperability of the vehicle is required in order to remove the component. The component 12 may be a cover panel. The component 12 may be a valve assembly. In examples in which the fuel tank assembly 1 is an aircraft fuel tank assembly, the component 12 may be a manhole cover panel, a temporary cover panel, a water drain valve assembly, or the like.

The sensor device 13 is integrated with the component 12. That is, the sensor device 13 is attached to the component 12 in any suitable manner such that the attachment is maintained during normal operation of a vehicle in which the fuel tank assembly 1 is comprised, and such that removal of the component 12 from the fuel tank assembly 1 results in simultaneous removal of the sensor device 13 from the fuel tank assembly 1. The integration of the sensor device 13 with the component 12 may be such that the sensor device is able to transmit data to a remote device. For example, a data port may be provided in an external surface of the component 12 for facilitating wired transmission of data to the remote device, or an antenna may be provided on or near an external surface of the component 12 for facilitating wireless transmission of data to the remote device.

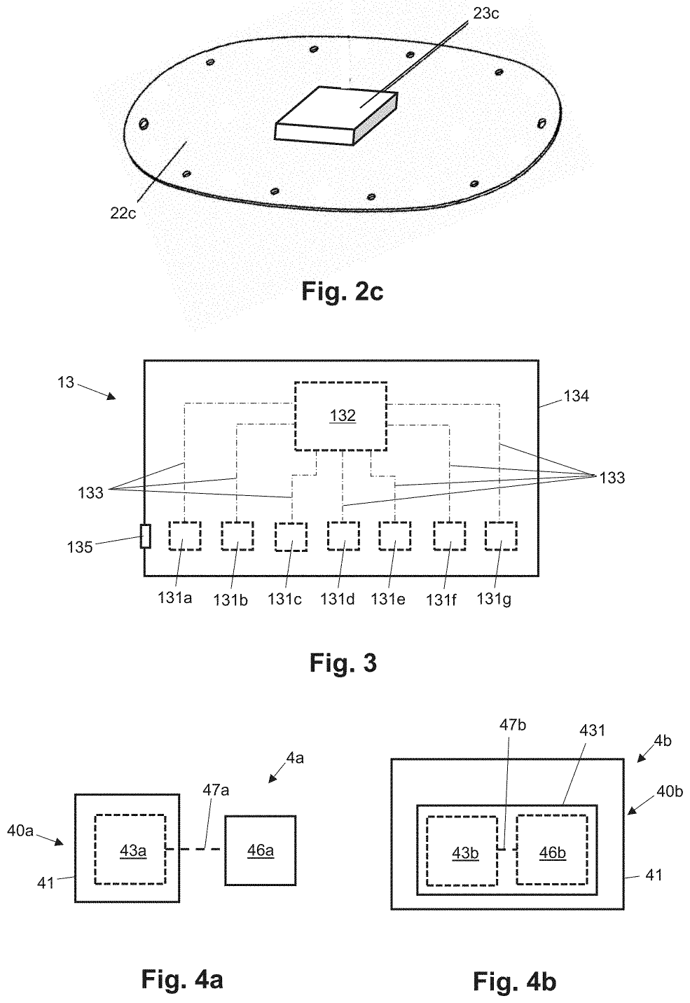

FIGS. 2a to 2c illustrate three different example components having integrated sensor devices, suitable for being comprised in the generic example vehicle fuel tank assembly 1.

FIG. 2a shows a first example component 22a, which has the form of a manhole cover for an aircraft wing. The manhole cover 22a is configured to be mechanically fastened to a wing skin panel which forms part of the main wall structure 11 of the fuel tank. The manhole cover 22a may have any suitable design known in the art, appropriate to the type of aircraft in which the fuel tank assembly 1 is comprised. The manhole cover 22a is removable from the aircraft wing during normal operation of the aircraft, to enable access to the interior of the fuel tank for inspection and/or maintenance purposes.

A sensor device 23a, which has substantially the same features as the sensor device 13 of FIG. 1, is fixedly attached to an inner surface of the manhole cover 22a. The opposite, outer surface (not visible in FIG. 2a) forms part of an outer surface of an aircraft wing. The attachment of the sensor device 23a to the inner surface may be effected using any suitable mechanism, such as bonding, fasteners, or the like. The sensor device 23a is located such that it will be in contact with fuel contained in the tank of the fuel tank assembly 1, even if the fuel level is very low.

FIG. 2b shows a second example component 22b, which has the form of a water drain valve for an aircraft fuel tank. The drain valve 22b is configured to be mounted through the floor (that is, the lower part of the main wall structure 11) of the fuel tank. The drain valve 22b has a housing 221. The housing 221 defines an interior space of the drain valve (not visible) and an inflow 222 configured to enable the contents of the fuel tank to flow into the interior space of the drain valve 22b. The housing 221 further defines an outflow 223, which is configured to enable fluid to flow from the internal space of the drain valve 22b to the exterior of the drain valve 22b. When the drain valve 22b is mounted on the fuel tank the outflow 223 extends through the main wall structure 11 and thereby enables fluid to flow from the internal space of the drain valve 22b to the external environment of the fuel tank.

The interior space of the drain valve 22b contains a valve arrangement (not visible) of any suitable type, which is configured to control the flow of fluid through the outflow 223. For example, a valve seat may be defined around the outflow 223, and a valve mechanism may be provided which is configured to seal against the valve seat to close the valve arrangement and to move away from the valve seat to open the valve arrangement. Such a valve mechanism may comprise a biasing arrangement configured to bias the valve mechanism into the closed state against the valve seat 64. The valve arrangement may be moveable into the open state by applying a force against the biasing arrangement, for example using a water drain tool.

A sensor device 23b, which has substantially the same features as the sensor device 13 of FIG. 1, is fixedly attached to an outer surface of the housing 221. The attachment of the sensor device 23b to the housing 221 may be effected using any suitable mechanism, such as bonding, fasteners, or the like. The sensor device 23b is located such that it will be in contact with fuel contained in the tank of the fuel tank assembly 1, even if the fuel level is very low.

FIG. 2c shows a third example component 22c, which has the form of a temporary cover panel for an aircraft wing. The temporary cover panel 22c is configured to form part of the fuel tank during a non-operational period of a vehicle in which the fuel tank is comprised. In this example the temporary cover panel 22c is configured to be fitted in place of a manhole cover having the same configuration as the example manhole cover 22a of FIG. 2a, and therefore has substantially the same shape and size as the example manhole cover 22a. However; the temporary cover panel 22c is configured to be mechanically fastened to the main wall structure 11 of the fuel tank using fewer fasteners than the manhole cover 22a. The temporary cover panel 22c is not intended to remain in place on the fuel tank during operation of the aircraft, so it may differ in terms of weight, material, strength, durability, visual appearance, or any other non-shape related property, from the corresponding manhole cover (which is intended to be in place on the fuel tank during operation of the aircraft).

A sensor device 23c, which has substantially the same features as the sensor device 13 of FIG. 1, is fixedly attached to an inner surface of the temporary cover panel 22c. The opposite, outer surface (not visible in FIG. 2c) forms part of an outer surface of an aircraft wing. The attachment of the sensor device 23c to the inner surface may be effected using any suitable mechanism, such as bonding, fasteners, or the like. The sensor device 23c is located such that it will be in contact with fuel contained in the tank of the fuel tank assembly 1, even if the fuel level is very low.

FIG. 3 is a schematic diagram of the example sensor device 13. The sensor device 13 is configured to obtain a sample of fuel contained in the fuel tank and to detect the presence of a plurality of different chemical and/or biological entities in the sample. The plurality of different chemical and/or biological entities is suitable for use in determining whether at least two different types of contaminant are present in the sample. The at least two different types of contaminant may comprise any combination of: water; particulates; bacteria; fungi; Diesel Exhaust Fluid; petroleum products different to the fuel intended to be present in the fuel tank; other chemical contaminates. The particular illustrated sensor device 13 is configured to detect the presence of a selected plurality of different chemical and/or biological entities that is suitable for simultaneously determining whether or not water is present in the sample, whether or not microbes are present in the sample, and whether or not at least one chemical contaminate is present in the sample.

In some examples, at least one of the chemical and/or biological entities in the plurality is one of the types of contaminants. For example, the sensor device may be configured to detect the presence of water in the sample, such a detection being suitable for determining whether water is present in the sample. In other examples at least one of the chemical and/or biological entities may not be one of the types of contaminants. For example, the sensor device may be configured to detect the presence of a chemical entity excreted by a particular type of microbe, in which case detection of that chemical entity indicates that the particular type of microbe is present in the sample. In some examples the sensor device is configured to detect a set of chemical and/or biological entities which, if present in combination, indicate the presence of a particular contaminant in the sample.

The sensor device 13 is packaged within a housing 134 which is configured to protect the elements of the sensor device 13 from the environment within the fuel tank. The housing 134 comprises a port 135 through which a sample of the fuel may be admitted into a sample collection space within the housing 134. The port 135 may be controllably openable and/or it may be configured to open and/or close in response to predefined environmental conditions. Alternatively the port 135 may be permanently open. The sample collection space may be substantially sealed off from a main interior space of the housing 134.

The sensor device 13 may be a lab-on-a-chip device. In some examples the sensor device 13 is a biosensor, or comprises a biosensor. The sensor device 13 comprises a plurality of sub-sensors 131a-g, each of which is configured to detect a different biological or chemical entity. For example, each sub-sensor may comprise a different chemical reagent or biorecognition element, each of which reacts to a different chemical or biological entity. That is, each sub-sensor may comprise a chemical reagent or biorecognition element that is configured to react with the chemical or biological entity which that sub-sensor is configured to detect. A biorecognition element may comprise, for example, tissue, a microorganism, an organelle, a cell receptor, an enzyme, an antibody, a nucleic acid, or the like. In some examples the sensor device 13 is based on microfluidic technology. Each sub-sensor is in fluid communication with the sample collection space, for example by means of one or more microfluidic channels, such that fuel contained in the sample collection space can be brought into contact with the chemical reagent(s) or biorecognition element(s) of that sub-sensor.

Each sub-sensor is configured to output detection information indicative of whether or not the chemical or biological entity that sub-sensor is configured to detect (the target analyte of that sub-sensor) is present in the fuel sample. In some examples each sub-sensor comprises a transducer configured to output a measurable electronic signal proportional to the presence of the target analyte in the sample. In such examples the detection information is comprised in the signal output by the transducer.

The sensor device 13 further comprises a communications interface 132. Each sub-sensor transducer is connected to the communications interface 132 by a communications link 133 suitable for transmitting an electrical signal. Each sub-sensor transducer is configured to transmit detection information generated by its respective sub-sensor to the communications interface 132 via its respective communications link 133. The communications interface thus receives detection information from each of the sub-sensors 131a-g. The communications interface 132 comprises a wireless communications apparatus for transmitting information wirelessly to a device located remotely from the sensor device 13. Such a device may be, for example, a portable computing device such as a tablet computer, a smartphone, or a dedicated maintenance device.

FIGS. 4a and 4b show two different example fuel contaminant detection systems 4a, 4b, each of which comprises a vehicle fuel tank assembly 40a, 40b according to an embodiment of the invention, and a processing device 46a, 46b. In the example of FIG. 4a the processing device 46a is remote from the fuel tank assembly 40a. In the example of FIG. 4b the processing device is integrated with the sensor device of the fuel tank assembly 40b. In each example the fuel tank assembly 40a, 40b may have the same features as the example fuel tank assembly 1 of FIG. 1. Each fuel tank assembly 40a, 40b comprises a sensor device 43a, 43b, each of which may have the same features as the example sensor device 13 of FIG. 3.

In the example of FIG. 4a the processing device 46 is located outside of a fuel tank 41 of the fuel tank assembly 40a, and is therefore located remotely from the sensor device 43a. The sensor device 43a is configured to transmit detection information to the processing device 46a. The detection information is transmitted over a wireless communications link 47a between the sensor device 43a and the processing device 46a.

The processing device 46a is configured to receive detection information from the sensor device 43 via the communications link 47, and to determine whether or not each of at least two different types of contaminant is present in fuel contained in the fuel tank based on the received detection information. The processing device 46 may perform the determination in any suitable manner known in the art. For example, the processing device 46 may be configured to access reference information which relates detection information to contaminant presence/absence for each type of contaminant that the fuel contaminant detection system 4 is configured to detect. The reference information may, for example, be stored on a memory of the processing device 46, or the processing device 46 may be configured to receive the reference information from a device remote to the processing device 46 (such as a cloud-based data storage system) via a wireless communications link.

The detection information received by the processing device 46 comprises a sub-set of detection information in respect of each sub-sensor of the sensor device 43. As discussed above, each sub-sensor is configured to detect a different chemical or biological entity. Each sub-set of the detection information therefore comprises information relating to the presence (or absence) in the sample of a different chemical or biological entity. Each sub-set of the detection information may comprise a value of one or more parameters. Such parameters may relate to the amount of the chemical or biological entity present in the fuel sample. Such parameters may include, for example, the amplitude of an electrical signal generated by the transducer of the sub-sensor. In some examples the detection information indicates whether or not the chemical or biological entity is present in the fuel sample. In some examples the detection information indicates an amount of the chemical or biological entity present in the fuel sample.

The form and content of the reference information used by the processing device 46 to determine whether or not the at least two contaminants are present in the fuel depends on the form of the detection information that the sensor device 43 is configured to output. For example, if the detection information originating from a given sub-sensor comprises an amplitude of an electrical signal, the reference information may comprise a look-up table linking signal amplitude values to corresponding concentrations (or simply to “present” or “absent” determinations) of one of the contaminants. In such examples the reference information may comprise a similar look-up table in respect of each sub-sensor of the sensor device 43. If the detection information comprises a value of a different parameter, the reference information may comprise a look-up table linking values of the different parameter to corresponding “present” or “absent” determinations or to concentration values. In other examples the reference information may comprise one or more algorithms, mathematical relationships, computer models, or any other type of information configured to output a determination of the presence or absence of a contaminant when provided with the received detection information as an input.

For some sensor device configurations and/or some contaminants, more than one sub-set of the received detection information may need to be processed in combination in order to determine whether a given contaminant is present in the fuel sample. For example, the presence in the fuel of a certain combination of chemical and/or biological entities may be definitively indicative of the presence in the fuel of a particular contaminant, whereas the presence of just one of those chemical and/or biological entities would not be definitively indicative of the presence of the particular contaminant. This may be the case where more than one type of contaminant can cause a given chemical or biological entity to be present. It may be the case that it is necessary to know the relative amounts in the fuel of the chemical and/or biological entities of the combination in order for the presence of the combination to be definitively indicative of the presence of the particular contaminant. The processing device 46 is configured to process the received detection data according to pre-programmed instructions which are based on the types of contaminant which the contaminant detection system 4 is configured to detect.

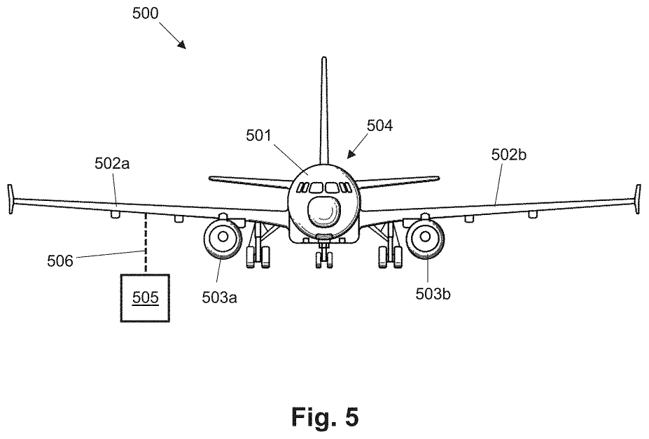

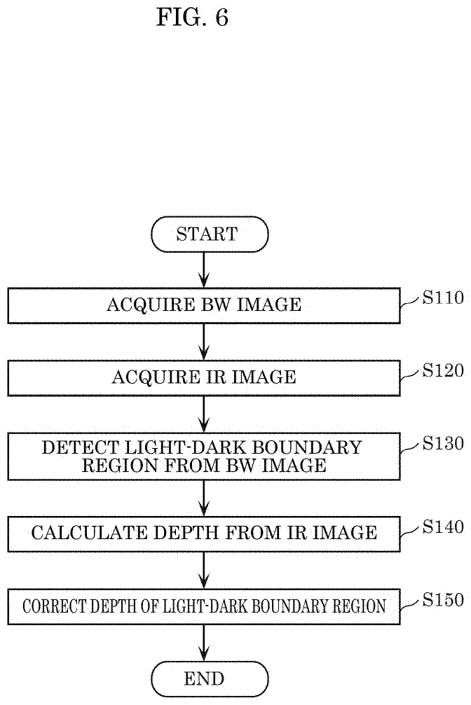

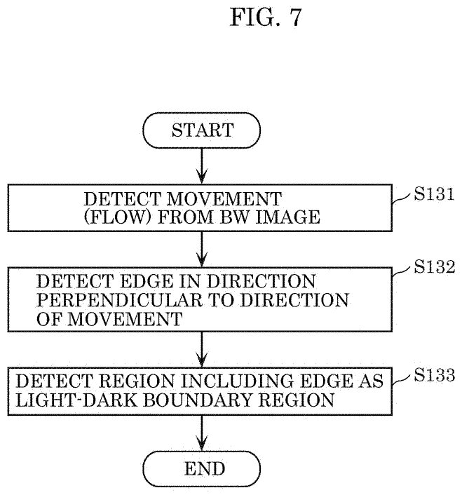

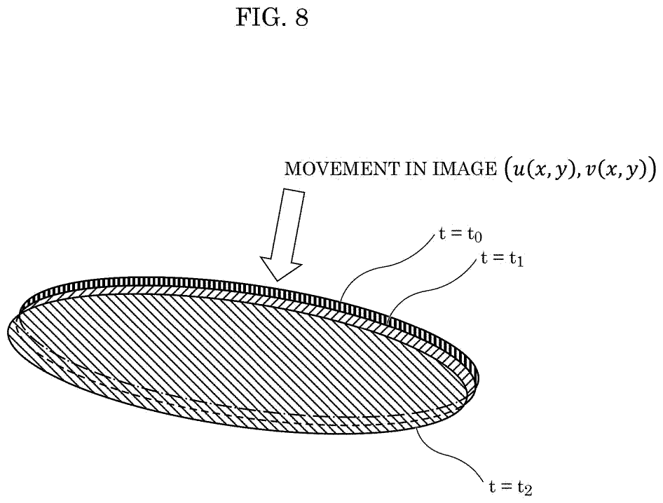

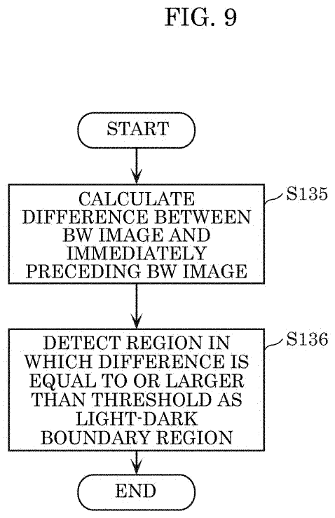

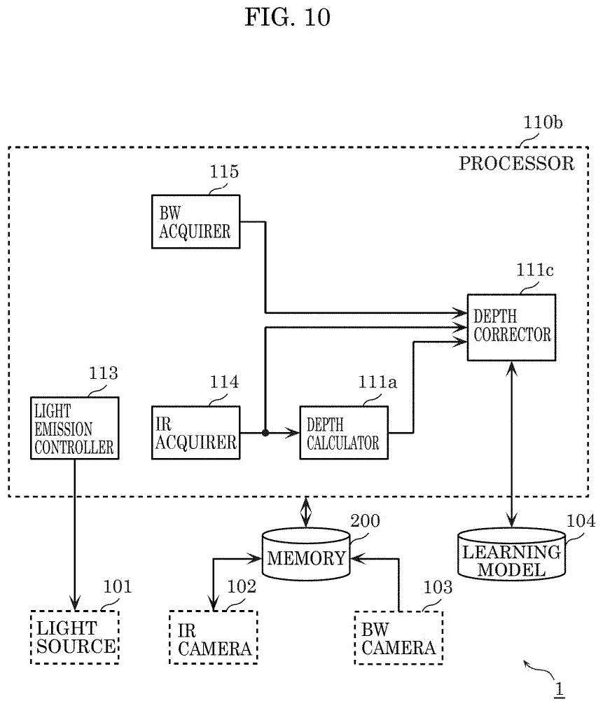

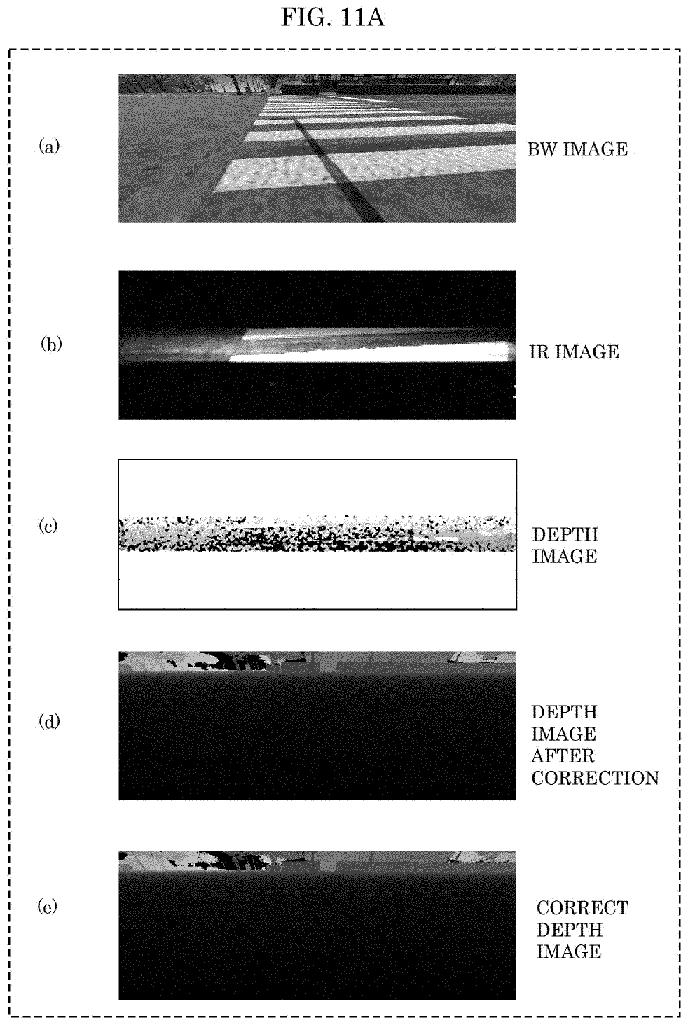

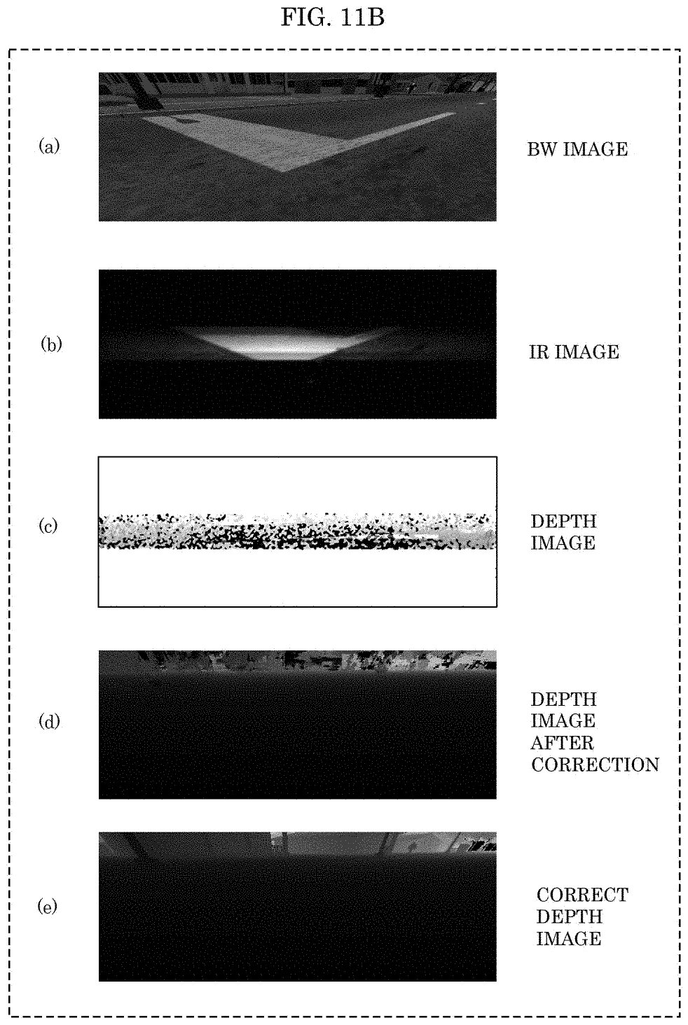

Alternative examples are possible in which the processing device 46 is integrated with the sensor device in a single housing, which is itself integrated with a fuel tank component. Once such example is illustrated by FIG. 4b. In such examples the communications link(s) between the FIG. 5 shows an example aircraft 500 comprising at least one fuel tank assembly according to the invention. The aircraft 500 comprises a fuselage 501, a pair of wings 502a and 502b, a pair of engines 503a and 503b, and an empennage 504. The aircraft 500 comprises a plurality of fuel tanks (not visible) and a fuel distribution system for transporting fuel from the tanks to the engines 503a, 503b. For example, the fuel tanks may comprise sealed compartments at least partly formed by the structure of the wings 502a, 502b, the empennage 504, and/or the fuselage 501, and/or any other part of the aircraft 500. Alternatively or additionally, the aircraft 500 may comprise one or more fuel tanks located within pressurised regions of the aircraft, such as the cabin and cargo bay.

At least one of these fuel tanks has a sensor device integrated with a component of the fuel tank in any of the manners described above, and therefore is comprised in a fuel tank assembly according to the invention. The fuel tank assembly so formed may have the same features as any of the example fuel tank assemblies described above. In some examples the sensor device of the fuel tank assembly is configured to be able to communicate with a remote processing device 505 via a wireless communications link 506. The remote processing device may have the same features as the example processing device 46 described above. In examples in which multiple fuel tanks of the aircraft 500 are comprised in fuel tank assemblies according to the invention, the sensor device of each fuel tank assembly may be configured to be able to communicate with the remote processing device 505.

Although the invention has been described above with reference to one or more preferred examples or embodiments, it will be appreciated that various changes or modifications may be made without departing from the scope of the invention as defined in the appended claims.

Although the invention has been described above mainly in the context of a fixed-wing aircraft application, it may also be advantageously applied to various other applications, including but not limited to applications on vehicles such as helicopters, drones, trains, automobiles and spacecraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A vehicle fuel tank assembly comprising:
a tank for storing fuel; and
a sensor device disposed inside the tank;
wherein the sensor device is integrated with a component of the tank; and
wherein the sensor device is configured to detect the presence of a plurality of different chemical and/or biological entities in fuel stored in the tank, the plurality of different chemical and/or biological entities being suitable for use in determining whether at least two different types of contaminant are present in the fuel.

2. The vehicle fuel tank assembly of claim 1, wherein the component is located at a lowest point of the fuel tank in a normal operational orientation of a vehicle in which the fuel tank is comprised.

3. The vehicle fuel tank assembly of claim 1, wherein the component is a removable component.

4. The vehicle fuel tank assembly of claim 3, wherein the component is configured to form part of the fuel tank during normal operation of a vehicle in which the fuel tank is comprised.

5. The vehicle fuel tank assembly of claim 4, wherein the component is a manhole cover or a drain valve.

6. The vehicle fuel tank assembly of claim 5 wherein the component is a temporary cover panel configured to form part of the fuel tank during a non-operational period of a vehicle in which the fuel tank is comprised.

7. The vehicle fuel tank assembly of claim 1, wherein the sensor device comprises a plurality of sub-sensors, each sub-sensor being configured to detect a different biological or chemical entity.

8. The vehicle fuel tank assembly of claim 7, wherein the sensor device further comprises a communications interface configured to receive detection information from the plurality of sub-sensors, the detection information being indicative of whether or not each of the chemical or biological entities which the plurality of sub-sensors is configured to detect is present in fuel contained in the fuel tank, and to transmit the received detection information to a remote processing device located outside of the fuel tank.

9. The vehicle fuel tank assembly of claim 1, wherein the sensor device is configured to obtain a sample of fuel contained in the fuel tank and to determine whether or not each of the at least two different types of contaminant is present in the sample.

10. The vehicle fuel tank assembly of claim 1, wherein the at least two different types of contaminant comprise any combination of: water; particulates; bacteria; fungi; Diesel Exhaust Fluid; petroleum products different to the fuel intended to be present in the fuel tank; other chemical contaminates.

11. The vehicle fuel tank assembly of claim 1, wherein the sensor device comprises a lab-on-a-chip device.

12. The vehicle fuel tank assembly of claim 11, wherein the lab-on-a-chip device is based on microfluidic technology.

13. The vehicle fuel tank assembly of claim 1, wherein the sensor device comprises one or more biorecognition elements.

14. The vehicle fuel tank assembly of claim 1, wherein the fuel tank assembly is an aircraft fuel tank assembly.

15. A fuel contaminant detection system comprising:
a vehicle fuel tank assembly according to claim 1, wherein the sensor device is configured to transmit detection information to a processing device located outside of the fuel tank; and
a processing device configured to:
receive detection information from the sensor device; and
determine whether or not each of at least two different types of contaminant is present in fuel contained in the fuel tank based on the received detection information.

16. An aircraft comprising a vehicle fuel tank assembly according to claim 1.
